(19) United States
(12) Patent Application Publication
(10) Pub. No.: US 2004/0167822 A1
(43) Pub. Date: Aug. 26, 2004

(54) Method and system for conducting online transactions

(75) Inventors: Michael L. Chasen, Chevy Chase, MD (US); Timothy R. Chi, Arlington, VA (US); Christopher E. Etesse, Washington, DC (US); William H. Langford, Washington, DC (US); Jianjun Xu, Rockville, MD (US)

Correspondence Address: WILMER CUTLER PICKERING HALE AND DORR LLP, 60 STATE STREET, BOSTON, MA, 02109, US

(73) Assignee: Blackboard Inc.

(21) Appl. No.: 10/373,924

(22) Filed: Feb. 25, 2003

(51) Int. Cl. G06F 17/60

(52) U.S. Cl. 705/26

(57) ABSTRACT

A transaction system conducts online transactions between a community of users associated with an organization and off-site vendors. Each user has an account for use in on-site transactions and other activities. The transaction system displays online items offered for sale by off-site vendors. The system can receive an order from a user for an item offered by an off-site vendor. The system determines if sufficient funds exist in the account of the user for the order and, if so, charges the account of the user for the order and transmits the order to the off-site vendor for order fulfillment. The system then pays the off-site vendor for the order.

### BACKGROUND OF THE INVENTION

1. Field of the Invention

The present invention relates generally to online transactions for goods and services and, more particularly, to a method and system for conducting online transactions between a community of persons associated with an organization and off-site vendors.

2. Description of Related Art

Community portals are commonly used by organizations to provide users access to a range of online resources and services. For example, in a college setting, portals operated by colleges provide students with online access to education resources (such as course materials, course assignments, and discussion boards) and online transaction services (e.g., for purchasing classroom supplies or making online tuition payments). These portals also often include conventional links to off-site vendors (such as, e.g., Internet merchants) who may offer products of interest to students. Students directly access the Web sites of the off-site vendors to purchase desired items, with payment being made typically by credit card. This process is inconvenient and time consuming as it requires students separately contact and make purchases from different off-site vendors having the desired products. It also typically requires students to maintain credit card accounts.

A need exists for an integrated commerce system that allows users associated with an organization of any type to more conveniently make on-site and off-site transactions.

### BRIEF SUMMARY OF EMBODIMENTS OF THE INVENTION

The present invention is generally directed to a transaction system used by a community of persons for conducting online transactions. The users of the transaction system can be persons associated with an organization such as, e.g., students at a college or employees of a business. Briefly, the transaction system is controlled by the organization and allows users to make online purchases from off-site vendors using user accounts established for on-site transactions and other uses.

A transaction system in accordance with one or more embodiments of the invention displays items offered for sale by off-site vendors. It can receive an order from a user for an item offered by an off-site vendor, determine if sufficient funds exist in the user's account for their order and, if so, charge the account for the order. The system transmits the order to the off-site vendor for order fulfillment, and pays the vendor for the order.

The transaction system thereby conveniently allows users to make transactions with off-site vendors using an integrated commerce system.

These and other features will become readily apparent from the following detailed description wherein embodiments of the invention are shown and described by way of illustration. As will be realized, the invention is capable of other and different embodiments and its several details may be capable of modifications in various respects, all without departing from the invention. Accordingly, the drawings and description are to be regarded as illustrative in nature and not in a restrictive or limiting sense with the scope of the application being indicated in the claims.

### BRIEF DESCRIPTION OF THE DRAWINGS

FIG. 1 is a simplified block diagram illustrating the implementation of a transaction system for use by a community of users in accordance with one or more embodiments of the invention;

FIG. 2 is a flow chart generally illustrating the process of conducting a transaction using the transaction system;

FIG. 3 is a screen shot of an exemplary portal page through which the transaction system can be accessed by a user;

FIG. 4 is a screen shot of an exemplary “user manage accounts” page accessible by a user;

FIG. 5 is a screen shot of an exemplary “virtual storefront” page accessible by a user; and

FIG. 6 is a screen shot of an exemplary “check-out” page used by the user in completing a transaction.

### DETAILED DESCRIPTION OF PREFERRED EMBODIMENTS

The present invention is generally directed to a transaction system used by a community of persons for conducting online transactions. The users of the transaction system can be persons associated with an organization such as, e.g., students at a college or employees of a corporate organization or other business. Briefly, the transaction system is operated by the organization and allows users to make online purchases from off-site vendors using user accounts established for on-site transactions and other uses.

As used herein, an off-site vendor is a merchant that offers goods and/or services to users of the transaction system and is generally independent of the organization owning or controlling the transaction system. Off-site vendors may or may not be physically distanced from the premises of the organization. Examples of off-site vendors include off-campus businesses and Internet vendors.

As used herein, an on-site entity is an entity that is associated with the organization owning or controlling the transaction system and that is physically located at or near the premises of the organization. For example, if the organization is a university or college, examples of on-site entities can include the bursar's office (which can accept online tuition payments), athletic departments (which can sell tickets for admission to sports events), campus stores, and student organizations.

The transaction system is particularly suited for use in a university or college campus environment as illustrated in some of the examples described herein. It should, however, be understood that transaction systems in accordance with various embodiments of the invention can be implemented in various other organization and community settings, including, e.g., in other educational organizations such as K-12 schools, corporate and other business entities, and governmental institutions.

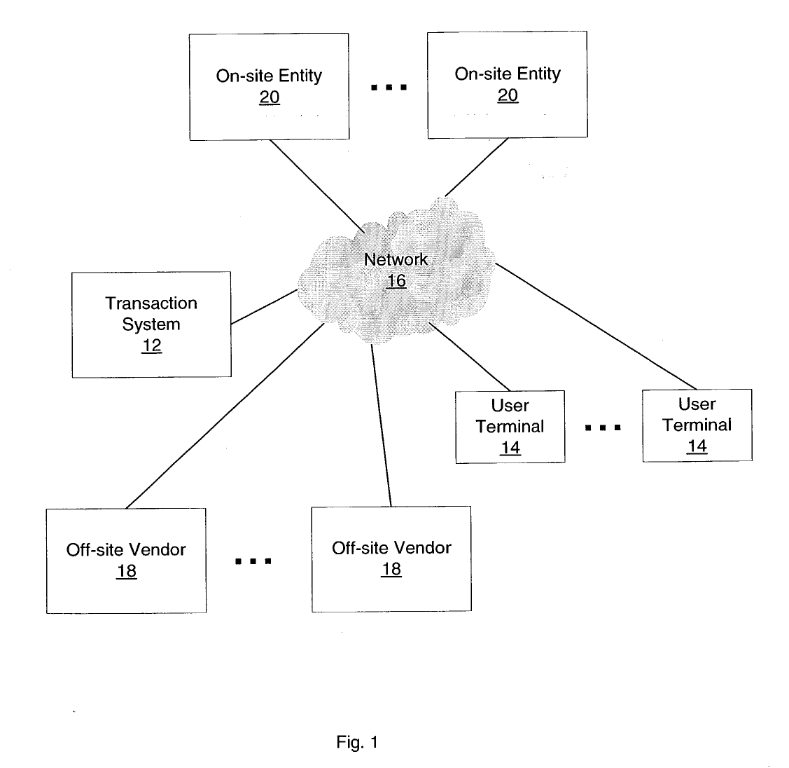

FIG. 1 schematically illustrates a representative network in which a transaction system 12 in accordance with one or more embodiments of the invention can be implemented. In general, the transaction system 12 includes a server system that communicates with a plurality of terminals or client devices 14 operated by system users (typically students in this example) over a network 16. The transaction system 12 is also linked to one or more off-site vendors 18 and one or more on-site entities 20 via the network 16.

The client terminal devices 14 operated by users are typically personal computers such as, e.g., Pentium-based desktop or notebook computers running a Windows operating system. Various other client terminal devices can also be used to conduct transactions with the transaction system 12 including, e.g., personal digital assistants (PDAs), cell phones and other wired or wireless electronic devices capable of communicating with the transaction system 12. As is well known, a representative personal computer includes a computer processing unit, memory, a keyboard, a pointing device such as a mouse or a touchpad, and a display unit. The screen of the display unit is used to present a graphical user interface (GUI) for the user. The GUI is supported by the operating system and allows the user to use a point and click method of input, e.g., by moving the mouse pointer on the display screen to an icon representing a data object at a particular location on the screen and pressing on the mouse buttons to perform a user command or selection. Also, one or more “windows” may be opened up on the screen independently or concurrently as desired.

The network 16 can comprise a computer network such as, e.g., the Internet (particularly the World Wide Web), Intranets, LANs, WANs, MANs, or other networks, or some combination thereof. Ordinarily, the users 14 and the on-site entities 20 are linked to the transaction system 12 via an intranet, and the off-site vendors 18 are linked to the transaction system 12 via the Internet.

The transaction system 12 includes a server system, which can be a Web server that operates a Web site and support files in the form of documents and pages (which can be in different formats such as text, graphics, images, sound, video, etc.). The Web server can provide users access to the files using a standard page description language known as Hypertext Markup Language (HTML). HTML provides basic document formatting and allows developers to specify links to other servers and files. These links include “hyperlinks,” which are text phrases or graphic objects that conceal the address of a site on the Web.

By way of example, the Web server can comprise a Pentium-based computer running a Windows operating system and a Web server program. The server can access one or more databases containing data on user accounts, transactions and vendor files.

The Web server can be integrated with a community Web portal system, if one exists, for the organization. A portal can offer users access to a broad range of resources and services including, e.g., online education resources such as course materials and assignments, and online discussions.

The client terminals 14 typically include browsers, which are known software tools used to access Web servers. Representative browsers for personal computers include, among others, Netscape Navigator and Microsoft Internet Explorer.

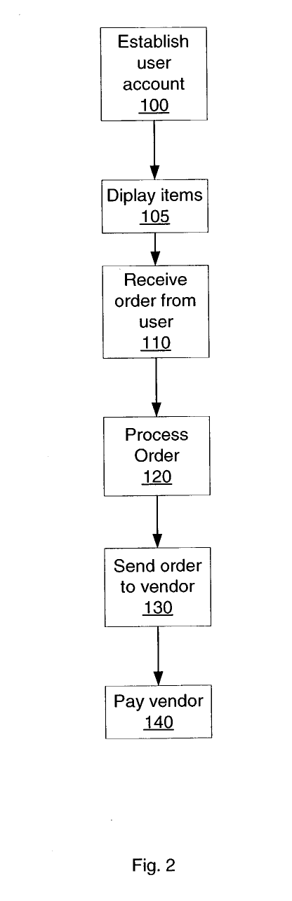

FIG. 2 is a flow chart generally illustrating use of the transaction system by users such as students for making online purchases. Briefly, an account is initially established for each student using the system at 100. The account is preferably a prepaid, debit account that can be funded by the student or by others (such as, e.g., his or her parents). Students can then make online purchases (or payments), for which their respective accounts will be charged (i.e., debited). Information on each student account, including information on balances available for making purchases and user profiles (containing, e.g., name and address information), is stored in student account files accessible by the transaction system.

The account established for each student is identified by an identifier such as an account number. For convenience, this identifier can be imprinted and/or magnetically encoded on a student identification card, which preferably has various other on-campus uses including, e.g., checking books out of a library and entering secured buildings. Thus, students conveniently have only one account number for use in making transactions as well as for identification and other purposes.

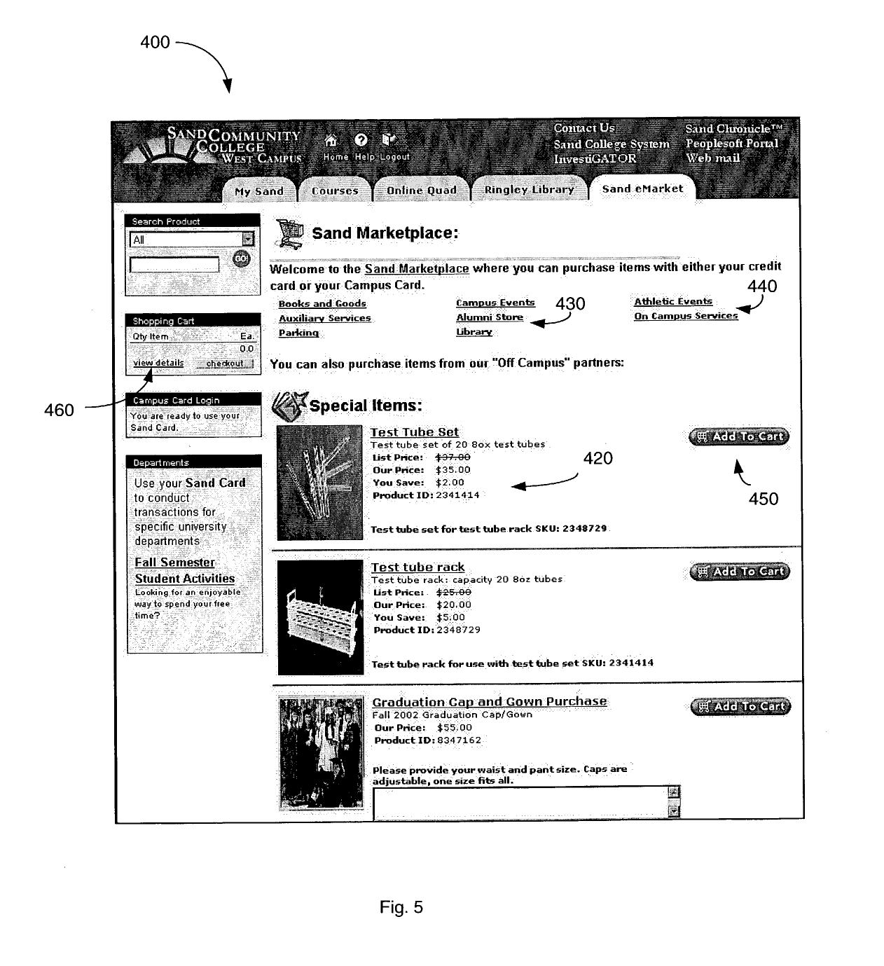

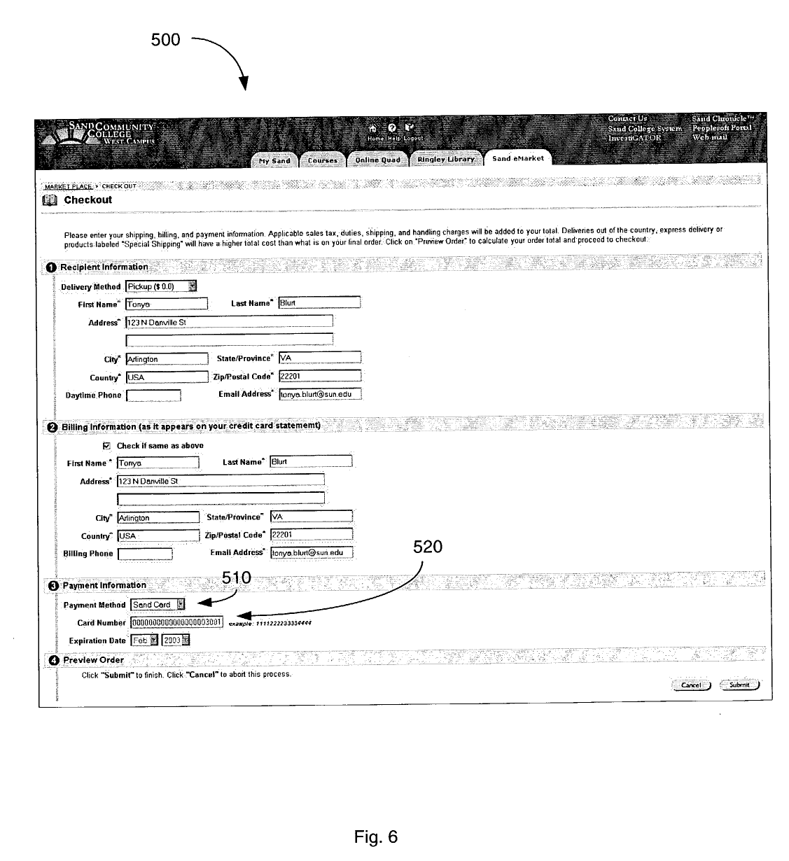

Once an account is established for a student, he or she can make transactions with off-site vendors as follows. At step 105, the transaction system 12 displays items offered by one or more off-site vendors online as will be described below with reference to FIG. 5. At step 110, the student uses a client terminal 14 to transmit to the transaction system 12 an online order for an item from an off-site vendor (as will be further described below with reference to FIGS. 5 and 6).

The transaction system 12 then processes the order at 120. In particular, the transaction system 12 retrieves information on the account of the student placing the order to determine if sufficient funds are available in the account to pay for the order. If sufficient funds exist, the account is charged for the order. The steps of determining if sufficient funds exist for the order and charging the account for the order are preferably performed in real-time, i.e., immediately after receiving the order from the student.

The transaction system 12 also transmits the order to the off-site vendor at 130. The order can be transmitted directly to an order fulfillment center associated with the vendor, which packages and sends the ordered merchandize to the student.

The transaction system 12 pays the vendor for the order at step 140. The payment to the vendor is preferably made periodically, i.e., at the end of a predetermined cycle (e.g., once a month). For convenience, the transaction system preferably issues a single payment for all orders processed by the system for that vendor during the cycle. This will include payment for purchases by all students for a particular vendor.

Thus, in accordance with one or more embodiments of the invention, orders received from users are validated (by checking if sufficient account balances are available and charging accounts for orders) in real-time. However, no actual funds are transferred from accounts when orders are placed by users. Funds are transmitted to a vendor at the end of a predetermined cycle for all transactions involving that vendor during the cycle.

Other vendor payment options are also possible. For example, the transaction system can pay the vendor for each order separately at about the time when orders are sent to the vendor.

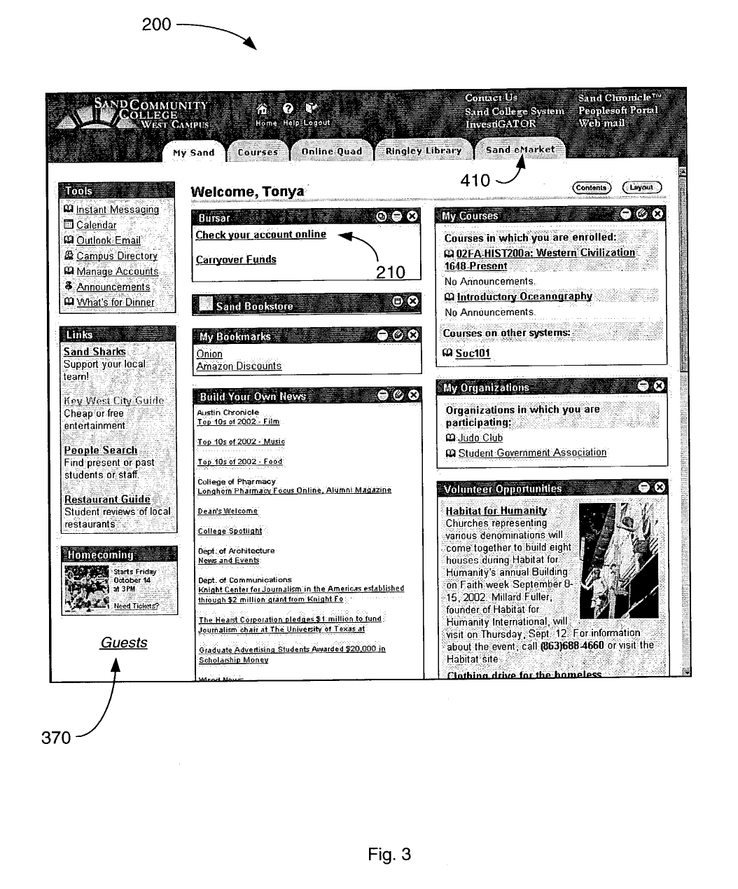

The transaction system is preferably accessed by users through a community portal, an example screenshot 200 of which is shown in FIG. 3. Students can access the portal through a login screen (not shown) where identification information (e.g., account number) is entered. Students are preferably required to also enter a password for security. The transaction system 12 authenticates the entered identification and password based on previously stored information in student files.

The portal conveniently offers users access to a broad range of resources and services including, e.g., email, calendars, course syllabus and assignment information, links to student organization and other sites, news, directories, and chat rooms.

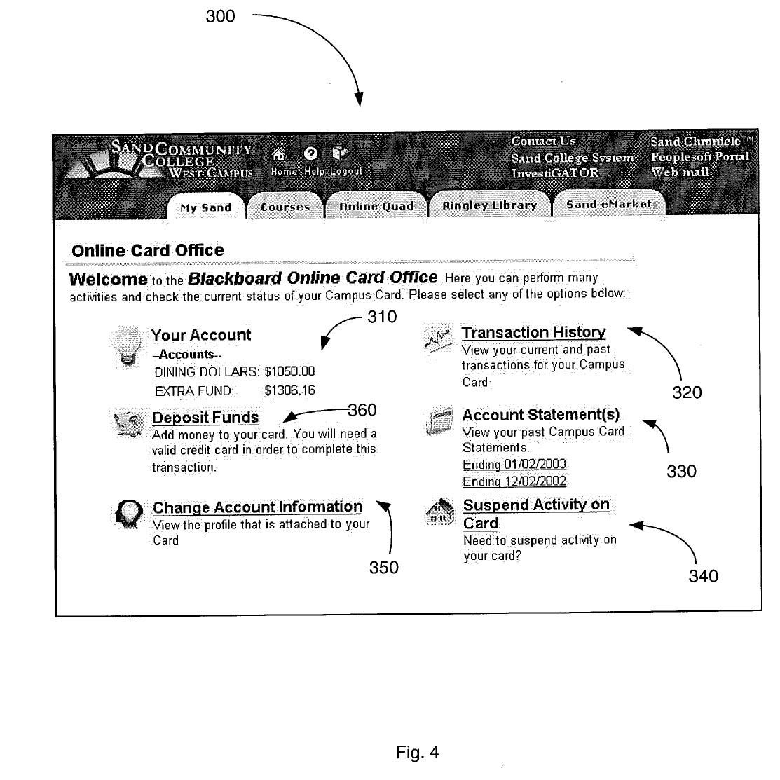

Users can access and manage their accounts by clicking on the “Check your account online” link indicated at 210. A “manage account” page is returned, an example screen shot 300 of which is shown in FIG. 4. The manage account page 300 displays account balance information (preferably in real-time) at 310. The transaction history of purchases made using the account can be accessed by selecting link 320.

In addition, prior account statements are accessible by clicking an account statements link 330. The statements are preferably Regulation E compliant, i.e., they meet Federal disclosure requirements for banking statements. In addition to being accessible online, the statements are preferably also emailed to students when issued.

If needed, the account can be suspended by the student as a result, e.g., of theft or loss of account identification and/or password information, by selecting an account suspend link 340. The suspension option may also be available to a funding source, such as parents, who can remotely access the system for this purpose as well as for monitoring the account.

Students can also change their account profile information (including shipping addresses for online purchases and access passwords) by selecting a change account information link 350.

Additional funds can be deposited in an account by selecting a deposit funds link 360. Funds can be deposited by entering credit card information and the amount to be deposited. Funds can also be deposited using bank debit cards and bank ATM cards. Other methods of depositing funds not using the accounts page are also possible including bank wire transfers and payment by check.

In addition to students, parents or others associated with the student can make deposits in the student's account. Deposits can be made by persons knowing the student's name and/or account number (preferably both). An account deposit form for making deposits can be accessed through a guest link 370 at the community portal 200 (shown in FIG. 3). Parents can accordingly conveniently provide funds as needed by students, and maintain some level of control on the spending habits of students.

The transaction system 12 can optionally charge a convenience fee for online deposits made to accounts. This is particularly useful for deposits made by credit cards since credit card companies ordinarily charge a small fee for the deposit transaction. By applying a convenience fee, some or all of the credit card fee can be recovered. The convenience fee can be, e.g., a percentage of the deposit (e.g., 2%) or alternatively a fixed fee per deposit (e.g., $5).

Purchases can be made by students through a virtual storefront or e-market page 400, an example screen shot of which is shown in FIG. 5. The e-market page 400 can be accessed by selecting the e-market tab 410 in the FIG. 3 portal. Products can be displayed directly on the e-market page 400 as shown, e.g., at 420 or can be found through department category links 430. For example, the link to athletic events 440 can be selected to display a page for sports ticket sales.

Products and services from both on-site entities and off-site vendors can be purchased through the e-market page 400. For example, an off-site vendor selling test tubes can have its products and price information displayed on the e-market page at 420. The products sold through the e-market page will often be related to courses in which students are enrolled. The system thereby advantageously provides a captive audience for vendors.

A student can purchase the test tubes offered by clicking on an “add to cart” button 450, which adds the item to an electronic or virtual shopping cart. Contents of the cart can be viewed by clicking on the “view details” link 460 in the shopping cart box.

Once all the desired items have been added to the shopping cart, the student can proceed to checkout. For convenience, the system 12 advantageously provides a single check-out for items purchased from multiple on-site and off-site vendors. An example screen shot of a check-out form 500 is shown in FIG. 6. The student is asked to enter or select shipping, billing, and/or payment information. For convenience, the transaction system 12 can automatically enter information in some or all fields in the form based on information stored the user profile files.

The user is given various options at 510 to make payment including, e.g., with a credit card or with the student debit account. When the debit account method of payment is selected (labeled in FIG. 6 as a “Sand Card”), the student account number is preferably automatically filled in the card number field at 520. The account number preferably can not be changed and is shown “grayed-out” to indicate so. By not allowing changes to the account number to be made, the system can reduce the risk of students using accounts of others for making purchases without authorization.

The student can then submit the checkout information to continue the transaction, and is preferably then provided with a confirmation of the order.

The transaction system provides a convenient method of shopping for users. Users can quickly find and easily purchase needed items online. Also conveniently, only a single account is needed for both on-site activities and for off-site purchases. In addition, the system reduces the need for students to have credit cards.

While a shopping cart model is described in the above example for online shopping, use of other models such as, e.g., the so-called one-click shopping model, which avoids the checkout procedure, is also possible.

The process described above and used by the transaction system 12 in conducting on-site and off-site transactions is preferably implemented in software. Accordingly, one of the preferred implementations of the invention is as a set of instructions (program code) in a code module resident in the random access memory of a computer. Until required by the computer, the set of instructions may be stored in another computer memory, e.g., in a hard disk drive, or in a removable memory such as an optical disk (for eventual use in a CD ROM) or floppy disk (for eventual use in a floppy disk drive), or downloaded via the Internet or some other computer network. In addition, although the various methods described are conveniently implemented in a computer selectively activated or reconfigured by software, one of ordinary skill in the art would also recognize that such methods may be carried out in hardware, in firmware, or in more specialized apparatus constructed to perform the specified method steps.

Having described preferred embodiments of the present invention, it should be apparent that modifications can be made without departing from the spirit and scope of the invention.

1. A method of conducting online transactions for a group of users associated with an organization having premises at a given site, each user having an account for use in on-site and off-site transactions, comprising:
identifying an item offered by an off-site vendor;
receiving an order from a user for the item;
charging the account of the user for the order;
transmitting the order to the off-site vendor for order fulfillment; and
paying the off-site vendor for the order.

2. The method of claim 1 wherein paying the off-site vendor for the order comprises paying the off-site vendor at the end of a cycle for all orders transmitted to said off-site vendor during said cycle from users.

3. The method of claim 1 wherein paying the off-site vendor for the order comprises paying the off-site vendor for the order at about the time the order is transmitted to the off-site vendor.

4. The method of claim 1 wherein identifying an item offered by an off-site vendor comprises displaying the item on a Web page.

5. The method of claim 4 wherein said Web page is accessible from a community portal of said organization.

6. The method of claim 1 wherein receiving an order from a user comprises receiving an order transmitted over a network by a client terminal operated by the user.

7. The method of claim 6 wherein said client terminal is a personal computer.

8. The method of claim 1 wherein steps of the method are implemented in a Web server.

9. The method of claim 1 wherein transmitting the order to the off-site vendor comprises transmitting the order to a fulfillment center associated with the off-site vendor.

10. The method of claim 1 wherein said organization is a university and said users are students attending said university.

11. The method of claim 1 further comprising providing a single checkout for orders for said user from a plurality of off-site vendors.

12. The method of claim 1 further comprising receiving payment to replenish said account.

13. The method of claim 12 wherein said payment to replenish said account is a credit card payment.

14. The method of claim 12 further comprising assessing a convenience fee for said payment.

15. The method of claim 1 further comprising determining if sufficient funds exist in the account of the user for the order prior to transmitting the order to the off-site vendor.

16. The method of claim 1 wherein said account is a prepaid, debit account.

17. A computer program product in computer-readable media for conducting transactions for a group of users associated with an organization having premises at a given site, each user having a debit account for use in transactions and activities at the site, the computer program product comprising instructions for causing a computer to:
identify an item offered for sale by an off-site vendor;
receive an order from a user for said item;
charge the account of the user for the order;
transmit the order to the off-site vendor for order fulfillment; and
pay the off-site vendor for the order.

18. The computer program product of claim 17 wherein instructions for causing a computer to pay the off-site vendor for the order comprise instructions to pay the off-site vendor at the end of a cycle for all orders transmitted to said off-site vendor during said cycle from users.

19. The computer program product of claim 17 wherein instructions for causing a computer to pay the off-site vendor for the order comprise instructions to pay the off-site vendor for the order at about the time the order is transmitted to the off-site vendor.

20. The computer program product of claim 17 wherein instructions for causing a computer to identify an item offered by an off-site vendor comprises instructions for displaying the item on a Web page.

21. The computer program product of claim 20 wherein said Web page is accessible from a community portal of said organization.

22. The computer program product of claim 17 wherein instructions for causing a computer to receive an order from a user comprises instructions for receiving an order transmitted over a network by a client terminal operated by the user.

23. The computer program product of claim 22 wherein said client terminal is a personal computer.

24. The computer program product of claim 17 wherein said computer comprises a Web server.

25. The computer program product of claim 17 wherein instructions for causing a computer to transmit the order to the off-site vendor comprises instructions for transmitting the order to a fulfillment center associated with the off-site vendor.

26. The computer program product of claim 17 wherein said organization is a university and said users are students attending said university.

27. The computer program product of claim 17 further comprising instructions for causing a computer to provide a single checkout for orders for said user from a plurality of off-site vendors.

28. The computer program product of claim 17 further comprising instructions for causing a computer to receive payment to replenish said account.

29. The computer program product of claim 28 wherein said payment to replenish said account is a credit card payment.

30. The computer program product of claim 28 further comprising instructions for causing a computer to assess a convenience fee for said payment.

31. The computer program product of claim 17 further comprising instructions for causing a computer to determine if sufficient funds exist in the account of the user for the order prior to transmitting the order to the off-site vendor.

32. The computer program product of claim 17 wherein said account is a prepaid, debit account.

33. A computer, comprising:
at least one processor;
memory associated with the at least one processor;
a display; and
a program supported in the memory for conducting transactions for a group of users associated with an organization having premises at a given site, each user having a debit account for use in transactions and activities at the site, the program comprising:
means for identifying an item offered for sale by an off-site vendor;
means for receiving an order from a user for said item;
means for determining if sufficient funds exist in the account of the user for the order;
means for charging the account of the user for the order;
means for transmitting the order to the off-site vendor for order fulfillment; and
means for paying the off-site vendor for the order.

34. The computer of claim 33 wherein said computer comprises a Web server.

35. A method of conducting transactions for a group of users associated with an organization having premises at a given location, comprising:
providing each user with an account;
conducting an on-site transaction at said location for a user using his or her account; and
conducting an off-site transaction for said user with one or more off-site vendors using said account.

36. The method of claim 35 wherein conducting said off-site transaction comprises:
identifying an item offered by an off-site vendor;
receiving an order from the user for the item;
charging the account of the user for the order;
transmitting the order to the off-site vendor for order fulfillment; and
paying the off-site vendor for the order.

37. A method of conducting online transactions for a group of users associated with an organization having premises at a given site, each user having an account for use in on-site and off-site transactions, comprising:
identifying an item offered by an off-site vendor and an item offered by an on-site entity;
receiving an order from a user for the items;
charging the account of the user for the order;
transmitting an order for the item offered by the off-site vendor to the off-site vendor for order fulfillment;
transmitting an order for the item offered by the on-site entity to the on-site entity for order fulfillment; and
paying the off-site vendor and the on-site entity for respective items ordered.

38. The method of claim 37 wherein paying the off-site vendor comprises paying the off-site vendor at the end of a cycle for all orders transmitted to said off-site vendor during said cycle from users.

39. The method of claim 37 wherein paying the off-site vendor comprises paying the off-site vendor at about the time the order is transmitted to the off-site vendor.

40. The method of claim 37 wherein identifying said items comprises displaying the items on a Web page.

41. The method of claim 40 wherein said Web page is accessible from a community portal of said organization.

42. The method of claim 37 wherein receiving an order from a user comprises receiving an order transmitted over a network by a client terminal operated by the user.

43. The method of claim 42 wherein said client terminal is a personal computer.

44. The method of claim 37 wherein steps of the method are implemented in a Web server.

45. The method of claim 37 wherein transmitting the order to the off-site vendor comprises transmitting the order to a fulfillment center associated with the off-site vendor.

46. The method of claim 37 wherein said organization is a university and said users are students attending said university.

47. The method of claim 37 further comprising providing a single checkout for orders for said user from a plurality of off-site vendors and on-site entities.

48. The method of claim 37 further comprising receiving payment to replenish said account.

49. The method of claim 48 wherein said payment to replenish said account is a credit card payment.

50. The method of claim 48 further comprising assessing a convenience fee for said payment.

51. The method of claim 37 further comprising determining if sufficient funds exist in the account of the user for the order prior to transmitting the order to the off-site vendor and to said on-site entity.

52. The method of claim 37 wherein said account is a prepaid, debit account.

53. The method of claim 6 wherein said client terminal is a personal digital assistant or a cell phone.

54. The computer program product of claim 22 wherein said client terminal is a personal digital assistant or a cell phone.

55. The method of claim 42 wherein said client terminal is a personal digital assistant or a cell phone.
